(19) United States
(12) Patent Application Publication
(10) Pub. No.: US 2011/0004484 A1
(43) Pub. Date: Jan. 6, 2011

(54) Communal Business Hubs and Methods for Forming the Same

(75) Inventor: Zola Stewart, Cincinati, OH (US)

Correspondence Address: DINSMORE & SHOHL LLP, 1900 CHEMED CENTER, 255 EAST FIFTH STREET, CINCINNATI, OH, 45202, US

(73) Assignee: FOCUS SOLUTIONS, Cincinnati, OH (US)

(21) Appl. No.: 12/829,811

(22) Filed: Jul. 2, 2010

Related U.S. Application Data
(60) Provisional application No. 61/222,710, filed on Jul. 2, 2009.

(51) Int. Cl. G06Q 90/00

(52) U.S. Cl. 705/1.1

(57) ABSTRACT

A method for forming a communal business hub includes obtaining a sale source center, wherein the sale source center includes an interior office space and a showroom, transforming the interior office space into a plurality of independent business zones, transforming the showroom into a communal business lobby, and occupying at least two of the plurality of independent business zones with a unique business, wherein each of the unique businesses do not compete against one another and each of the unique businesses share the communal business lobby.

### CROSS-REFERENCE TO RELATED APPLICATIONS

This patent application claims priority to provisional Patent Application Ser. No. 61/222,710 filed Jul. 2, 2009.

### TECHNICAL FIELD

The present invention relates to office infrastructures and, more specifically, forming communal business hubs from sale source centers such as automotive dealerships.

### BACKGROUND

Many businesses require their own independent operating space for progressing and achieving their main business purpose. As such, businesses may buy or lease their own office space such that they maintain independence without the obtrusions of other companies. However, the overhead and costs associated with buying or leasing their own office space may prevent the growth and well being of the company. While sharing office space with other businesses may provide an alternative, each business may seek unique office space requirements making it difficult to coalesce with others operating in substantially different fields. Moreover, businesses sharing office space may seek to retain the independence perceived by customers by enforcing strict distinctions between office space, which in turn may inhibit interaction between the neighboring businesses. Even if businesses are able to share office space with others in an independent manner, it may be difficult to identify available and affordable locations that satisfy the needs of each independent business.

Accordingly, a need exists for alternative methods for forming communal business hubs from sale source centers such as automotive dealerships.

### SUMMARY

In one embodiment, a method for forming a communal business hub is provided. The method can include obtaining a sale source center, wherein the sale source center includes an interior office space and a showroom, transforming the interior office space into a plurality of independent business zones, and transforming the showroom into a communal business lobby. The method can further include occupying at least two of the plurality of independent business zones with a unique business, wherein each of the unique businesses do not compete against one another and each of the unique businesses share the communal business lobby.

In another embodiment, a method for forming a communal business hub from an automotive dealership is provided. The method can include obtaining the automotive dealership, wherein the automotive dealership includes an interior office space, a showroom, an exterior vehicle lot and a vehicle service center, transforming the interior office space into a plurality of independent business zones, and transforming the showroom into a communal business lobby. The method can further include occupying at least two of the plurality of independent business zones with a unique business, wherein each of the unique businesses do not compete against one another and each of the unique businesses share the communal business lobby, and wherein at least one of the unique businesses comprises an automobile oriented business utilizing the exterior vehicle lot and the vehicle service center.

In yet another embodiment, a communal business hub is provided. The communal business hub includes a plurality of independent business zones formed from an interior office space of an automotive dealership, each independent business zone being occupied by a unique business, wherein each of the unique businesses do not compete against one another, a communal business lobby formed from a showroom of the automotive dealership, the communal business lobby being shared be each of the unique businesses, and a vehicle service center utilized by at least one of the unique businesses.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a communal business hub formed from a sale source center according to one or more embodiments shown and described herein; and

FIG. 2 depicts a method for forming a communal business hub from a sale source center according to one or more embodiments shown and described herein.

### DETAILED DESCRIPTION

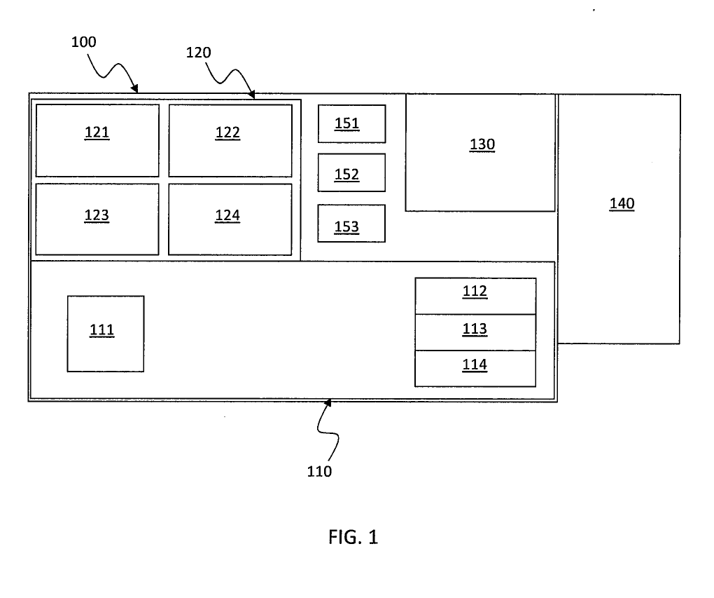

FIG. 1 generally depicts one embodiment of a communal business hub. The communal business hub may generally comprise a plurality of independent business zones formed from an interior office space of a sale source center such as an automotive dealership. The communal business hub may further comprise a communal business lobby formed from a showroom of the sale source center. Multiple unique businesses that do not compete with one another may each occupy their own independent business zone within the communal business hub. The unique businesses may further share the communal business lobby such that each unique business has its own independent business zone and shared access to the communal business lobby.

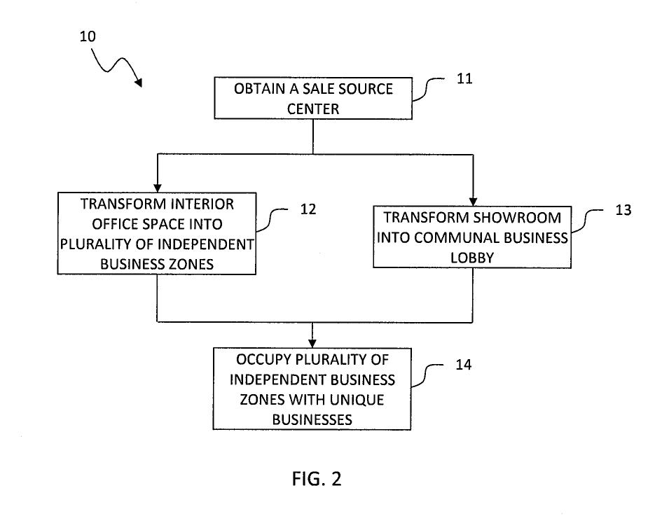

Referring now to FIGS. 1 and 2, a method 10 for forming a communal business hub 100 is illustrated. The method 10 for forming a communal business hub 100 may first comprise obtaining a sale source center in step 11. As used herein, a “sale source center” refers to a place of business from which goods are sold and which comprises at least an interior office space and a showroom. The interior office space of the sale source center can comprise any area within a building that is utilized for a plurality of work stations such as desks, cubicles, offices or the like. The interior office space of the sale source center may comprise any number of work stations such that the works stations can be transformed into a plurality of independent business zones 120 that are separated from one another as will become appreciated herein. The showroom of the sale source center can comprise any open area within the same building comprising the interior office space that was used to display one or more of the goods that were sold at the sale source center. For example, where the sale source center comprises an automotive dealership, the showroom may comprise the area inside the building where one or more vehicles are or were offered for interior display. The showroom and the interior office space may comprise any size with respect to each other and the overall sale source center. For example, the showroom display may be substantially the same size as the interior office space, larger than the interior office space or smaller than the interior office space. Furthermore, the interior office space and the showroom display may comprise the entire sale source center, or may only comprise a portion of the sale source center.

For example, in one embodiment, the sale source center may comprise one or more additional features that may either be retained or transformed in forming the communal business hub 100. In one embodiment, the sale source center may further comprise an exterior vehicle lot 140 which can be used for employee and customer parking and/or vehicle storage. In another embodiment, the sale source center may comprise a vehicle service center 130 either attached to or integral with the sale source center. The vehicle service center 130 may comprise any facility operable to produce, repair or otherwise work on one or more vehicles. For example, the vehicle service center 130 may comprise a vehicle mechanic shop and/or an oil change facility with may comprise actuating lifts for providing access to the underside of a vehicle. Alternatively or additionally, the vehicle service center 130 may comprise a body shop and/or paint shop for working on the appearance of a vehicle such as eliminating body damage or applying a new coat of exterior paint or finishing coat. In yet another embodiment, the sale source center may comprise an automotive dealership comprising both an exterior vehicle lot and one or more vehicle service centers. Other possible additional features of the sale source center may include, without limitation, kitchen space, document or supply storage space, bathroom facilities, HVAC equipment, and/or any other similar amenity as will become appreciated herein.

The sale source center may be obtained in step 11 by any means available. For example, in one embodiment, the sale source center may be obtained in step 11 by acquiring an abandoned or foreclosed business lot comprising the sale source center. In one particular embodiment, such as where the abandoned business lot comprises an abandoned automotive dealership, the sale source center may be obtained in step 11 by acquiring the abandoned automotive dealership from its owner. Furthermore, the sale source center obtained in step 11 may be obtained using any operable financial structure. For example, the sale source center obtained in step 11 may be purchased outright from the previous owner, may be purchased from the previous owner using one or more secured or unsecured loans, leased from the owner for a defined or on going period of time, or donated by an owner or a community. It should be appreciated that any other alternative method for obtaining a sale source center comprising an interior office space and a showroom may otherwise be employed in step 11 of method 10 for forming a communal business hub 100.

Still referring to FIGS. 1 and 2, after the sale source center is obtained in step 11, the interior office space in transformed into a plurality of independent business zones 120 in step 12 and the showroom is transformed into a communal business lobby in step 13. Transforming the interior office space into the plurality of independent business zones 120 in step 12 may comprise dividing the interior office space into a plurality of identifiable sections wherein each individual section can be utilized as office space by a different business. For example, in one embodiment, the interior office space may be transformed in the plurality of independent business zones 120 by constructing walls separating each independent business zone (e.g., 121, 122, 123 and 124 in FIG. 1) such that each independent business zone has its own entry or is separated from the others by one or more walls. In another embodiment, the interior office space may be transformed into the plurality of independent business zones 120 by utilizing cubicles, markings, or any other type of visual and/or physical barrier. Furthermore, the interior office space of the sale source center can be transformed into any number of independent business zones 120 such that at least two independent business zones are produced. For example, in one embodiment, such as that illustrated in FIG. 1, the plurality of independent business zones 120 may comprise four distinct independent business zones 121, 122, 123 and 124. In another embodiment, the interior office space may be transformed into even more independent business zones 120. In yet another embodiment, the number of interior independent business zones 120 may be dynamic over time such as creating more independent business zones 120 to satisfy the demand by additional unique businesses, or consolidating one or more of the independent business zones 120 into a single independent business zone to house a larger unique business requiring greater space. Furthermore, each of the plurality of independent business zones 120 may comprise any size relative to the others to accommodate the unique business working therein. For example, each of the plurality of independent business zones 120 may comprise the same size and/or configuration as the others, or each may comprise a unique size and configuration adapted to serve the needs of the particular unique business working therein.

In one particular embodiment, such as where the interior office space already comprises some degree of walls or cubicles sectioning off some work stations from others, the transformation of the interior office space into the plurality of independent business zones 120 may be adapted to the specific building such that preexisting structures are incorporated into separating the independent business zones 120 from one another. For example, where the interior office space already contains a section of offices and a section of cubicles, the offices and cubicles may be separated from one another, or split into two sections, each comprising some offices and some cubicles, by the addition of a wall, marking or other boundary.

Transforming the showroom of the sale source center into the communal business lobby 110 in step 13 may comprise modifying the showroom into a mutually accessible business support area that can be utilized by all unique businesses in the plurality of independent business zones 120. For example, in one embodiment, transforming the showroom of the sale source center into the communal business lobby 110 in step 13 may comprise modifying the showroom to include one or more reception stations 111 and/or one or more conference rooms 112, 113, 114. Reception stations 111 can comprise any desk, table, entryway or greeting area where an employee may answer and direct calls and/or greet customers as they enter the communal business hub 100. In one embodiment, the reception station 111 may include a communication terminal operable to communicate with each of the plurality of independent business zones 120. Such an embodiment may allow for a common reception station 111 to greet any customer entering the communal business lobby 110 of the communal business hub 100 and notify the proper unique business of their guest's presence. Conference rooms 112, 113, 114 may comprise any area or room wherein a group of employees and/or customers may gather as needed as related to the business of one or more of the unique businesses. For example, conference rooms may include large conference tables, presentation areas such as whiteboards or projectors, or any other suitable amenity. Furthermore, the communal business lobby 110 can comprise any number of conference rooms 112, 113, 114, each comprising any size and configuration suitable for the communal business lobby 110. The one or more reception stations 111 and the one or more conference rooms 112, 113, 114 may be positioned such that each of the unique businesses occupying the plurality of independent business zones 120 can maintain shared access. For example, in one embodiment, such as where the showroom was positioned adjacent the interior office space in the sale source center, the a reception station 111 may be positioned at one end of the showroom while one or more conference rooms 112, 113 and 114 are positioned at the other end of the showroom. The communal business lobby 110 may further comprise a large gathering area where a plurality of individuals and/or unique businesses may gather. The large gathering area may comprise one or more of the conference rooms 112, 113, 114 (where present), or may simply comprise open space that is a remnant of the showroom of the sale source center.

Transforming the interior office space into the plurality of independent business zones 120 in step 12 and transforming the showroom into the communal business lobby 110 in step 13 may occur in any relative order. For example, in one embodiment the interior office space is transformed into the plurality of independent business zones 120 in step 12 prior to transforming the showroom into the communal business lobby 110 in step 13. In another embodiment, the showroom is transformed into the communal business lobby 110 in step 13 prior to transforming the interior office space into the plurality of independent business zones 120 in step 12. In yet another embodiment, transforming the interior office space in the plurality of independent business zones 120 in step 12 and transforming the showroom into the communal business lobby 110 in step 13 may occur simultaneously.

In other embodiments, additional transformations may also occur. For example where the sale source center comprised kitchen space, the kitchen space may be converted into a communal kitchen 151 that can be accessed by all unique businesses occupying the plurality of independent business zones 120. Likewise, where the sale source center comprised bathroom facilities, the bathroom facilities may be converted into communal bathroom facilities 152 that can be accessed by all unique businesses occupying the plurality of independent business zones 120. In yet another embodiment, where the sale source center comprised storage space, the storage space may be converted into communal storage space 153 for storing office supplies, document retention or any other necessary storage items. Such features may be transformed into single communal features, or may be transformed into segmented features such that each unique business has access to only their designated segment of the feature (e.g., on a portion of the storage space).

Referring to FIG. 1, in one particular embodiment where the sale source center comprised a vehicle service center 130, the vehicle service center 130 may be transformed into a vehicle service center 130 to be used by a single unique business or by a plurality of the unique businesses in the communal business hub 100, each of which are automotive oriented businesses. For example, in one embodiment, a single unique business may solely occupy the vehicle service center 130 such that their independent business zone becomes the vehicle service center 130 and no other unique business occupy or have access to the vehicle service center 130. In another embodiment, one or more unique businesses occupying one or more the of the independent business zones 120 may also occupy or have access to the vehicle service center 130. For example, a car painting company and an oil change company may each occupy their own independent business zone 120 but also have access to their own respective portions of the vehicle service center 130. In another embodiment, an exterior vehicle lot 140 may also be connected to the communal business hub 100 and occupied or shared by one or more of the unique businesses similar to the vehicle service center 130 discussed above.

Still referring to FIGS. 1 and 2, after the interior office space is transformed into the plurality of independent business zones 120 in step 12 and the showroom is transformed into the communal business lobby 110 in step 13, at least two, and up to all, of the plurality of independent business zones 120 may be occupied with a unique business in step 14. As used herein, “unique businesses” refers to businesses that do not directly compete with one another with substantially identical classes of goods or services. Unique businesses may include multiple businesses that relate to the same general field (such as vehicles where the sale source center comprised an automotive dealership) but offer distinct goods or services within that field (such as body work versus oil changes). The plurality of independent business zones 120 are occupied such that no independent business zone 120 is occupied by more than one unique business. In one embodiment, each unique business occupies a single independent business zone 120. For example, where there are four independent business zones 121, 122, 123 and 124 as illustrated in FIG. 1, each may be occupied by a different unique business such that the communal business hub 100 comprises four unique businesses. In another embodiment, a single unique business may occupy more than one independent business zones 120 such as when separating two or more departments within a single unique business. By occupying each of the plurality of independent business zones 120 with a unique business, but also allowing shared access to the communal business lobby 110 (and any features therein) for each unique businesses, the unique businesses may efficiently pool resources for communal features while still enjoying independent space in their own independent business zone 120.

The unique businesses occupying the independent business zones 120 may comprise any business so long as no two unique businesses directly compete with one another with substantially identical classes of goods or services as discussed above. In one embodiment, one or more of the unique businesses may be dedicated to community services (i.e., services that promote, assist or directly influence the local community). For example, a unique business may include job placement or other career related services to local individuals, community or government consulting, or any other service that may promote the relationship between the communal business hub 100 and the local community. In another embodiment, one or more of the unique businesses may comprise a business directed to green technologies (i.e., businesses that provide goods or services that substantially promote green technologies). Businesses that promote green technologies may include any business that offers products or services that improve the environment or otherwise reduce the damage thereto. Such businesses may include recycling organizations, non-profit organizations aimed at promoting environmental awareness or any other applicable business. Such embodiments may thereby promote community awareness or attitude towards the remaining unique businesses in the communal business hub 100 by their proximal and business association.

In one embodiment, the method 10 for forming a communal business hub 100 may further comprise hosting development networking events in the communal business lobby 110 for each of the unique businesses in the communal business hub 100. The development networking events may comprise any event that either promotes networking between the one or more unique businesses in the communal business hub 100 or helps develop one or more business skill sets for one or more unique businesses in the communal business hub 100. For example, in one embodiment, the development networking event may comprise a social event such as providing food and/or entertainment to promote interaction amongst the employees of the various unique businesses. Such an event may encourage education and awareness about each others businesses such that new contacts, leads and ideas may be formed there between. In another embodiment, the development networking event may comprise business education geared to improve or educate one or more areas of business relevant to at least one of the unique businesses in the communal business hub 100. For example, the development networking event may comprise education regarding accounting, finance, client growth, business awareness or any other similar aspect that can improve the success of the unique business. Such an embodiment may thereby allow for not only providing office space to a plurality of unique businesses, but also coaching and development resources.

In yet another embodiment, the method 10 for forming a communal business hub 100 may further comprise providing auxiliary business support to one or more of the unique businesses occupying the plurality of independent business zones 120 in the communal business hub 100. Auxiliary business support may include staffing, computers, office supplies or similarly related solutions. For example, in one embodiment, permanent or temporary staffing may be provided to one or more of the unique businesses as needed. Where the sale source center comprised an automotive dealership, the staffing solutions may include one or more mechanics or similarly knowledgeable individuals to the unique business (or the unique businesses) that utilize the vehicle service center 130.

In one particular embodiment, the method 10 for forming a communal business hub 100 may further include forming a second communal business hub (not shown) in connection with the first business hub 100. For example, the method 10 may include obtaining a second sale source center, wherein the second sale source center comprises a second interior office space and a second showroom. The method 10 may then include transforming the second interior office space into a second plurality of independent business zones, transforming the second showroom into a second communal business lobby, and occupying at least two of the second plurality of independent business zones with a second unique business, wherein each of the second unique businesses do not compete against one another. In such an embodiment, each of the unique businesses (from the first communal business hub 100) and the second unique businesses (from the second communal business hub) can share the communal business lobby 110 of the communal business hub 100 and the second communal business lobby of the second communal business hub. Such an embodiment may allow for unique businesses in one communal business hub to have access to at least the communal business lobbies (and conference rooms or other amenities therein) from various other communal business hubs. This can allow for a unique business to promote greater geographical coverage in its business footprint as well as provide greater networking opportunities between unique businesses in various communal business hubs.

It should now be appreciated that communal business hubs may be formed by transforming a sale source center which included at least an interior office space and a showroom. Specifically, once a sale source center such as an automotive dealership is obtained, the interior office space can be transformed into a plurality of independent business zones and the showroom can be transformed into a communal business lobby. Each of the independent business zones may thereby be occupied by a unique business with shared access to the communal business lobby. Forming one or more communal business hubs may thereby take advantage of unused sale source centers, promote economic efficiency for a plurality of unique businesses and/or provide increased businesses growth, development and both internal and external networking opportunities to each unique business.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for forming a communal business hub, the method comprising:
obtaining a sale source center, wherein the sale source center comprises an interior office space and a showroom;
transforming the interior office space into a plurality of independent business zones;
transforming the showroom into a communal business lobby; and
occupying at least two of the plurality of independent business zones with a unique business, wherein each of the unique businesses do not compete against one another and each of the unique businesses share the communal business lobby.

2. The method of claim 1 wherein the sale source center further comprises an exterior vehicle lot.

3. The method of claim 1 wherein the sale source center further comprises a vehicle service center.

4. The method of claim 1 wherein the sale source center comprises an automotive dealership.

5. The method of claim 1 further comprising:
obtaining a second sale source center, wherein the second sale source center comprises a second interior office space and a second showroom;
transforming the second interior office space into a second plurality of independent business zones;
transforming the second showroom into a second communal business lobby; and
occupying at least two of the second plurality of independent business zones with a second unique business, wherein each of the second unique businesses do not compete against one another and wherein each of the unique businesses and the second unique businesses share the communal business lobby of the communal business hub and the second communal business lobby of a second communal business hub.

6. The method of claim 1 wherein the plurality of independent business zones are separated by walls.

7. The method of claim 1 wherein the communal business lobby comprises one or more reception stations and one or more conference rooms.

8. The method of claim 1 further comprising hosting development networking events in the communal business lobby for each of the unique businesses in the communal business hub.

9. The method of claim 1 further comprising providing auxiliary business support to one or more of the unique businesses.

10. The method of claim 1 wherein one or more of the unique businesses is dedicated to community services.

11. The method of claim 1 wherein one or more of the unique businesses is dedicated to green technologies.

12. A method for forming a communal business hub from an automotive dealership, the method comprising:
obtaining the automotive dealership, wherein the automotive dealership comprises an interior office space, a showroom, an exterior vehicle lot and a vehicle service center;
transforming the interior office space into a plurality of independent business zones;
transforming the showroom into a communal business lobby; and
occupying at least two of the plurality of independent business zones with a unique business, wherein each of the unique businesses do not compete against one another and each of the unique businesses share the communal business lobby, and wherein at least one of the unique businesses comprises an automotive oriented business utilizing the exterior vehicle lot and the vehicle service center.

13. The method of claim 12 further comprising hosting development networking events in the communal business lobby for each of the unique businesses in the communal business hub.

14. The method of claim 12 further comprising providing auxiliary business support to one or more of the unique businesses.

15. The method of claim 12 wherein one or more of the unique businesses is dedicated to community services.

16. The method of claim 12 wherein one or more of the unique businesses is dedicated to green technologies.

17. A communal business hub comprising:
a plurality of independent business zones formed from an interior office space of an automotive dealership, each independent business zone being occupied by a unique business, wherein each of the unique businesses do not compete against one another;
a communal business lobby formed from a showroom of the automotive dealership, the communal business lobby being shared be each of the unique businesses; and
a vehicle service center utilized by at least one of the unique businesses.

18. The communal business hub of claim 17 further comprising an exterior vehicle lot utilized by at least one of the unique businesses.

19. The communal business hub of claim 17 further comprising a communal kitchen, a communal bathroom facility and/or a communal storage space.

20. The communal business hub of claim 17 wherein the communal business lobby comprises one or more reception stations and one or more conference rooms.
